(19) United States
(12) Patent Application Publication
(10) Pub. No.: US 2026/0149398 A1
(43) Pub. Date: May 28, 2026

(54) SYSTEMS AND METHODS FOR PROTECTING A MOTOR MAGNET DURING A THREE-PHASE SHORT

(71) Applicant: Rivian IP Holdings, LLC, Irvine, CA (US)

(72) Inventor: Boru Wang, Pasadena, CA (US)

(21) Appl. No.: 18/963,016

(22) Filed: Nov. 27, 2024

(51) Int. Cl. H02P 23/00; H02K 11/33; H02P 23/14; H02P 29/032

(52) U.S. Cl. CPC H02P 23/0027; H02K 11/33; H02P 23/14; H02P 29/032

(57) ABSTRACT

Systems and methods for protecting a motor magnet during a three-phase short condition are provided herein. A system includes power electronics configured to provide current to a three-phase electric motor using a plurality of switches, and control circuitry configured to transition the three-phase electric motor to a three-phase short condition using the plurality of switches, and alternate between the three-phase short condition and a three-phase open condition using the plurality of switches based on a transient current of the three-phase electric motor. In some embodiments, transitioning from the three-phase short condition to the three-phase open condition is in response to the transient current exceeding a threshold. In some embodiments, the transition to a three-phase short condition is in response to at least one of the plurality of switches being damaged.

### INTRODUCTION

The present disclosure is directed to systems and methods for transitioning an electric motor to a three-phase short condition. More specifically, the present disclosure is directed to protecting the motor during a three-phase short condition by alternating between the three-phase short condition and a three-phase open condition based on a transient current of the motor.

### SUMMARY

Operation of an electric motor (e.g., within an electric vehicle) may include various failsafe procedures. These procedures should be capable of protecting the motor, including a magnet of the motor, as well as the battery coupled to the electric motor. In some instances, a switch of a motor drive may fail (e.g., get stuck in an open or closed position) and create a voltage imbalance. To prevent this voltage imbalance from causing excess current to flow onto the battery, other motor switches may be controlled to create a short-circuit condition (which may be preceded by one open-circuit condition) across the motor. However, this short-circuit condition may cause excess current to flow across the electric motor and demagnetize the magnet of the electric motor. The one open-circuit condition may be introduced before the short-circuit condition to reduce the excess current flow, but this approach may fail to protect magnets when faced with relatively large voltage imbalances. In accordance with embodiments of this disclosure, alternating short-circuit and open-circuit conditions (i.e., a short-circuit condition, followed by at least one instance of alternating between an open-circuit condition and a short-circuit condition) are applied as a failsafe approach for protecting the motor magnet in response to voltage imbalance. In some embodiments, respective amounts of time associated with each short-circuit condition and each open-circuit condition are determined based on a temperature of the motor, a speed of the motor, properties of the motor magnet, an amount of voltage imbalance, or any combination thereof.

In accordance with embodiments of this disclosure, systems, methods, and electric vehicles are provided for protecting a motor magnet during a three-phase short. A system includes power electronics configured to provide current to a three-phase electric motor using a plurality of switches. The system also includes control circuitry configured to transition the three-phase electric motor to a three-phase short condition using the plurality of switches, and to alternate between the three-phase short condition and a three-phase open condition using the plurality of switches based on a transient current of the three-phase electric motor. A method includes operating the control circuitry to achieve the aforementioned transitioning and alternating. An electric vehicle includes a three-phase electric motor coupled to one or more wheels, as well as the power electronics and the control circuitry.

In some embodiments, the control circuitry is configured to alternate between the three-phase short condition and the three-phase open condition by transitioning the three-phase electric motor from the three-phase short condition to the three-phase open condition in response to the transient current exceeding a threshold.

In some embodiments, the control circuitry is configured to determine the threshold based on a temperature associated with the three-phase electric motor.

In some embodiments, the control circuitry is configured to alternate between the three-phase short condition and the three-phase open condition by transitioning the three-phase electric motor from the three-phase open condition to the three-phase short condition based on the transient current and a steady state three-phase short current of the three-phase electric motor.

In some embodiments, the control circuitry is configured to determine the steady state three-phase short current based on motor speed.

In some embodiments, the control circuitry is configured to transition the three-phase electric motor from the three-phase open condition to the three-phase short condition when a distance between a vector associated with the transient current and the steady state three-phase short current is below a threshold distance.

In some embodiments, the control circuitry is further configured to determine whether the transient current satisfies a steady state three-phase short current condition, and terminate the alternating in response to the transient current satisfying the steady state three-phase short current condition.

In some embodiments, the control circuitry is further configured to determine whether one of the plurality of switches is damaged, and transition the three-phase electric motor to the three-phase short condition in response to determining that one of the plurality of switches is damaged.

In some embodiments, the plurality of switches comprises first, second, and third switches respectively coupled to first, second, and third phases of the three-phase electric motor, and the control circuitry is configured to transition the three-phase electric motor to the three-phase short condition by closing the first, the second, and the third switches.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative block diagram of components of a three-phase electric motor system, in accordance with some embodiments of the present disclosure;

FIG. 2 is an illustrative graph showing temperature-dependent properties of a magnet based on a current applied across a motor including the magnet, in accordance with some embodiments of the present disclosure;

FIG. 3 is a first illustrative graph showing a transient current profile associated with a three-phase short condition;

FIG. 4 is a second illustrative graph showing a transient current profile associated with a three-phase short condition;

FIG. 5 is a third illustrative graph showing a transient current profile associated with a three-phase open condition followed by a three-phase short condition;

FIG. 6 is an illustrative flowchart of a method for transitioning a motor to a three-phase short condition by alternating between three-phase short and three-phase open conditions, in accordance with some embodiments of the present disclosure;

FIG. 7 is a fourth illustrative graph showing a current profile associated with a method for protecting a motor magnet during a three-phase short-circuit condition, in accordance with some embodiments of the present disclosure; and

FIG. 8 is an illustrative flowchart of a method for protecting a motor during transition to a three-phase short condition, in accordance with some embodiments of the present disclosure.

### DETAILED DESCRIPTION

An electric motor system (e.g., as may be used as part of an electric vehicle) may include a three-phase motor (e.g., including a magnetic material), a motor drive (e.g., including three pairs of switches, each coupled to a respective phase of the three-phase motor), and a power supply (e.g., a battery). The electric motor system may use electric power to rotate driven components (e.g., including a drivetrain and wheels).

During operation of the electric motor system, a part of the motor drive (e.g., any switch of the three pairs of switches) may fail, which may cause large transient current to flow into other components such as a battery. The other components may be damaged by those large transient current flows. To protect the other components from potential damage, a short-circuit condition may be implemented across the three phases of the three-phase motor. This short-circuit condition may cause the large transient currents to flow across the motor instead of flowing into other components (e.g., the battery).

A consequence of applying the short-circuit condition to protect the battery is that the magnetic material of the three-phase motor may demagnetize when the large transient current flows across the motor. To protect the motor and the other components, a temporary open-circuit condition may be implemented across the three-phase motor before implementing the short-circuit condition across the motor. However, that temporary open-circuit condition may not protect the magnet from demagnetizing when the transient currents are too large.

In accordance with some embodiments of this disclosure, in response to there being a transient current within an electric motor system, control circuitry implements alternating short-circuit and open-circuit conditions across a three-phase motor. For example, alternating short- and open-circuit conditions may refer to implementing two respective short-circuit conditions, with an open-circuit condition implemented between those two short-circuit conditions. These alternating short-circuit and open-circuit conditions protect magnetic material of the motor from demagnetizing while protecting, for example, a battery of the electric motor system from exposure to the transient current. Moreover, these alternating short-circuit and open-circuit conditions are configured to terminate when a steady-state short-circuit current flows across the motor.

In some embodiments, the control circuitry determines to transition to the three-phase short condition and implements the alternating conditions based on a transit current (e.g., a non-steady state current) associated with the electric motor. For example, the transient current may develop in response to at least one switch of the electric motor system being damaged, and/or in response to an electromotive force (e.g., exerted by the three-phase motor) on a battery of the electric motor exceeding a threshold. The control circuitry executes the transition by implementing a short-circuit condition across the motor and then alternating between open-circuit conditions and short-circuit conditions until the short-circuit condition causes the transient current to satisfy a condition that is associated with a steady state current (e.g., the transient current stabilizes to, or sufficiently close to, a steady state value). In some embodiments, during the transition, the control circuitry limits the transient current to being below a threshold value (e.g., based on protecting equipment of the electric motor system, including preventing demagnetizing of a magnet of the electric motor).

In some embodiments, the control circuitry determines a current across the electric motor and compares the current to a current limit or threshold associated with the motor (e.g., where the limit may be based on a model of the susceptibility of the magnet to demagnetizing). Based on the limit and the transient current magnitude, the control circuitry determines how long to implement each of the alternating short-circuit and open-circuit conditions, as well as how many of each condition to implement, to protect the motor and other components such as a battery.

In an illustrative example, an electric vehicle is being operated at a relatively high speed (e.g., on a highway). During this operation, a switch in the motor drive of the electric vehicle is damaged (e.g., fails). The damaged switch may cause a voltage across terminals of the motor to exceed the voltage across terminals of the battery used to drive the motor. This voltage imbalance can induce backflow of unregulated current from the motor to the battery. To protect the battery from this backflow of unregulated current, control circuitry may determine to apply a short-circuit condition across the motor. However, to apply only one short-circuit condition (which may or may not be preceded by only one open-circuit condition) risks demagnetizing a magnet of the motor. Therefore, the control circuitry implements alternating short-circuit conditions and open-circuit conditions to protect the battery while limiting an amount of current that flows across the magnet of the motor.

Accordingly, as described above and as further described in detail below, methods and corresponding systems are provided for using control circuitry to protect a motor magnet during a three-phase short-circuit condition.

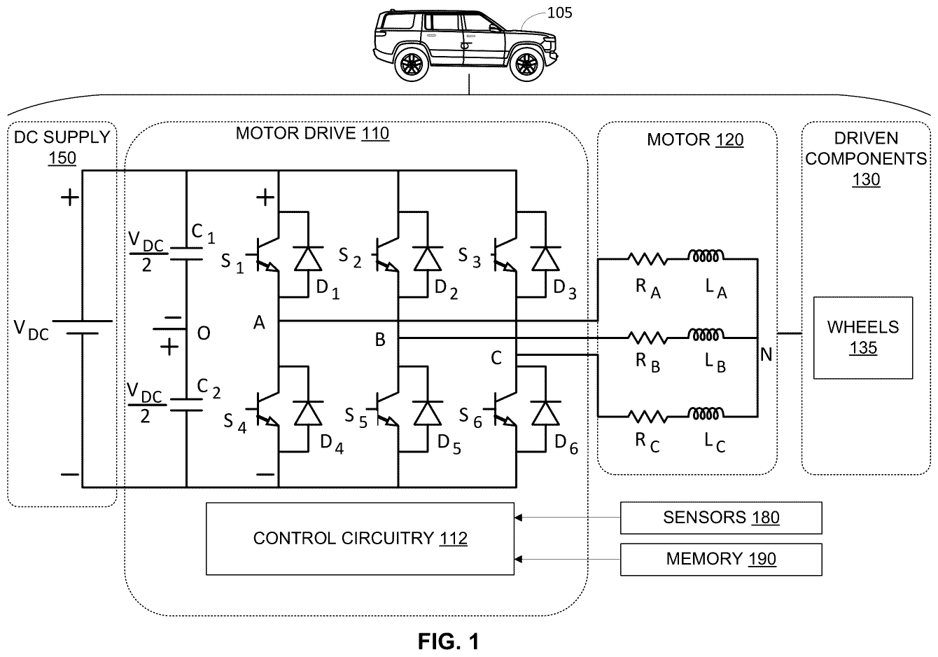

FIG. 1 shows illustrative motor drive 110, motor 120, driven components 130, and DC supply 150 (e.g., including a battery and, optionally, supporting power converters and other power electronics), in accordance with some embodiments of the present disclosure. Any one or more of the illustrative motor drive 110, motor 120, and DC supply 150, including respective components thereof, may be referred to as power electronics. In some embodiments, the power electronics are included within electric vehicle 105. Motor drive 110 includes switches S₁-S₆, which may be IGBT devices, as shown, or any other suitable switches. In some embodiments, diodes D₁-D₆ are arranged across corresponding switches S₁-S₆ to provide flyback current paths.

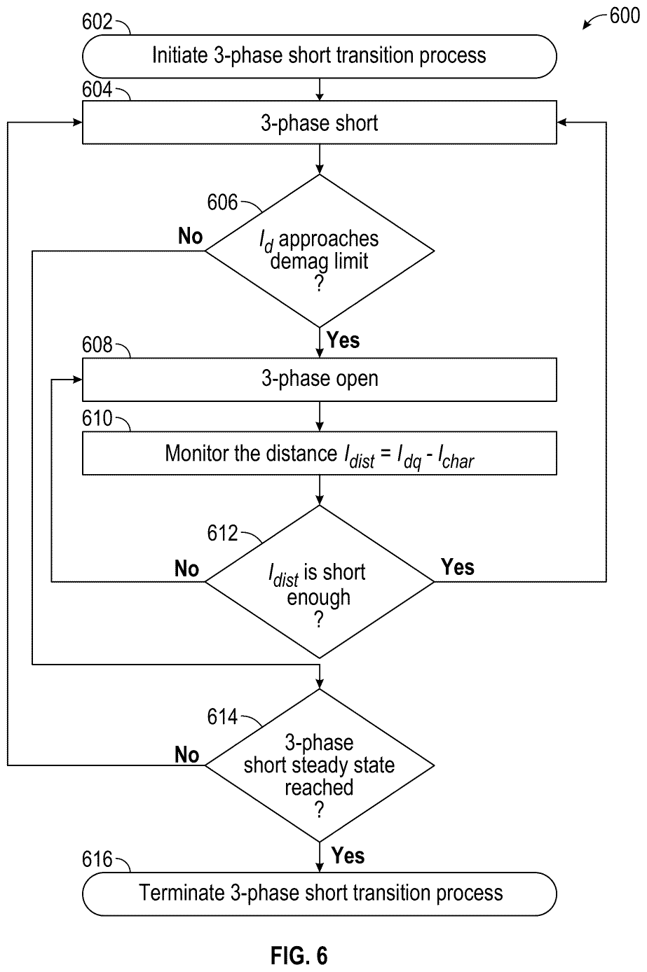

DC supply 150 provides energy for motor drive 110 to drive phases of motor 120 (e.g., which may be a three-phase motor, as illustrated). Motor drive 110 includes control circuitry 112, which is configured to provide control signals to open or close switches S₁-S₆. The control circuitry 112 may operate switches S₁-S₆ (e.g., using a pulse width modulation or other suitable switching scheme) to convert a DC input voltage (e.g., provided by DC supply 150) to an AC output voltage and AC output current to drive motor 120. During this operation, it is possible that one or more of the switches may fail (e.g., become stuck in an open or closed position). In response to a switch failure, there is the possibility of a high voltage developing across motor 120 and presenting a back electromotive force on DC supply 150. To prevent the back electromotive force from driving unregulated current through the DC supply 150, without causing damage to motor 120, control circuitry 112 may implement alternating short and open conditions across motor 120 using one or more approaches of this disclosure (e.g., as described above, and as shown and described at least in connection with FIGS. 6-8).

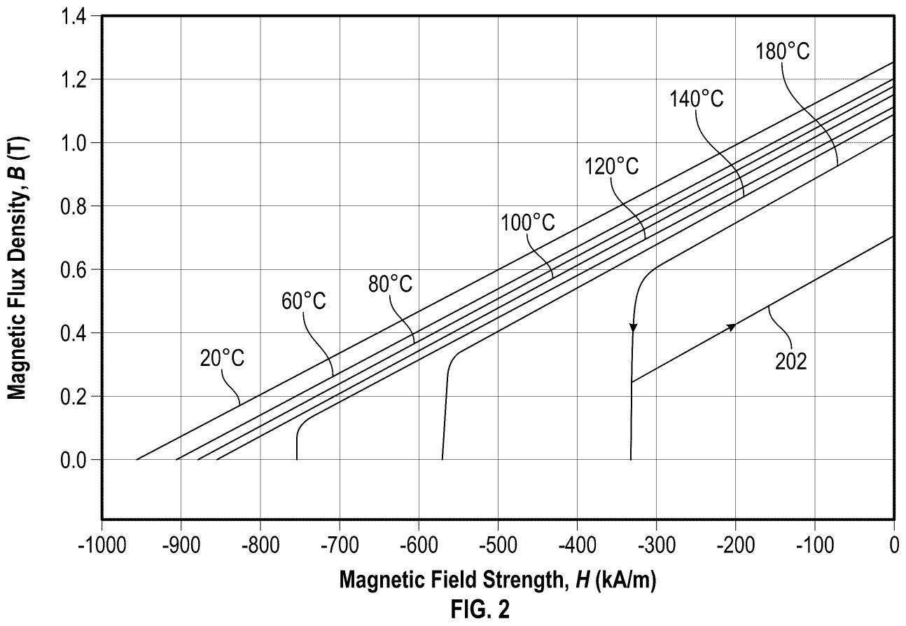

Control circuitry 112 may be coupled to sensors 180 and memory 190 to implement the alternating open-circuit and short-circuit conditions across motor 120. For example, control circuitry may rely on one or more sensors 180 to determine a current across motor 120, respective conditions of switches S₁-S₆ (e.g., whether or not the switch has failed), and/or an electromotive force applied to DC supply 150. In some embodiments, a current sensor determines current across motor 120 based on measuring 3-phase current output of motor drive 110 (e.g., as may flow between the positive (+) and negative (−) ends of motor drive 110, as annotated in FIG. 1). Control circuitry 112 may rely on memory 190 to determine a maximum current level (e.g., based on a susceptibility to demagnetizing) that may flow across motor 120 (e.g., as further shown and described in connection with FIG. 2). Control circuitry 112 may rely on both sensors 180 and memory 190 to determine how long to implement each open-circuit condition and each short-circuit condition when implementing the alternating open-circuit and short-circuit conditions across motor 120.

As used herein, a short condition (i.e., a short-circuit condition) may refer to any configuration of switches S₁-S₆ in which the three-phase terminals of motor 120 (e.g., circuit nodes “A”, “B”, and “C”, as annotated in FIG. 1) are electrically connected to each other. For example, the short-circuit condition may include having all three switches S₁-S₃ in closed positions or having all three switches S₄-S₆ in closed positions. Under certain conditions, including some conditions described in connection with this disclosure, current can flow through the motor during the short condition.

As used herein, an open condition (i.e., an open-circuit condition) may refer to any configuration of switches S₁-S₆ in which there is no path for current to flow in and out of motor 120. For example, the open-circuit condition may include having all six switches S₁-S₆ in open positions.

In some embodiments, sensors 180 include one or more current sensors, voltage sensors, torque sensors, temperature sensors, sensors configured to sense any other suitable property or change thereof, any other suitable sensors, or any combination thereof. For example, sensors 180 may include an optical encoder, a magnetic encoder, a potentiometer, or other suitable device for determining a rotary position or speed (e.g., of a magnet of motor 120). In some embodiments, sensors 180 include a temperature sensor (e.g., a thermocouple, a resistance temperature detector, a thermistor, an optical thermal measurement sensor) for measuring or determining a temperature of any one or more of the elements shown in FIG. 1. In some embodiments, sensors 180 include a voltage sensor for determining a back electromotive force (e.g., that is applied on the DC supply 150 by the motor 120).

Considering the aforementioned power electronics as part of electric vehicle 105, the motor 120 may be coupled to driven components 130 (e.g., including a drivetrain) to rotate a plurality of wheels 135 (e.g., two or four wheels). Motor 120 may be coupled to the driven components 130 to rotate the wheels 135 based on signals provided by motor drive 110 using energy provided by DC supply 150. That is, motor 120 may be coupled to one or more wheels 135 through one or more driven components 130.

FIG. 2 is an illustrative graph showing temperature-dependent properties of a magnet based on a current applied across a motor including the magnet. The vertical axis of FIG. 2 shows magnetic flux density, which represents the magnetic properties of the magnet. The horizontal axis of FIG. 2 shows magnetic field strength across the magnet, which is based on an electric current applied across the motor and the magnet. In some embodiments, the magnetic field strength may correlate with the motor speed (e.g., at relatively high speeds of electric vehicle 105, the magnetic field strength is greater than at relatively slow speeds). The group of curves labeled 20° C. through 180° C. represents illustrative temperature-dependent relationships between the magnetic flux density and the magnetic field strength.

The aforementioned group of curves shows how at a threshold temperature (e.g., above 120° C. for the data shown in FIG. 2, which is merely illustrative), the magnet deviates from a linear relationship between the magnetic flux density and the magnetic field strength across the range of possible magnetic field strengths. In particular, the 120, 140, and 180° C. curves show that the linear relationship drops off to a nearly vertical line at respective magnetic field strengths of approximately −760, −580, and −325 kA/m. This drop-off represents deterioration of the magnet's magnetic flux density (e.g., it may be referred to as a demagnetizing condition or demagnetizing region). In other words, as shown by path 202, if a magnet is exposed to operating conditions in the drop-off region, upon reducing the magnitude of the magnetic field strength, the magnetic flux density will not return to its pre-exposure level; that is, the magnet has been demagnetized (e.g., partially demagnetized). In contrast, at 20° C., for example, the magnetic field strength coupled be increased to −1000 kA/m, and upon reducing this field strength back to 0, the magnetic flux density would recover to ˜1.24 T, as shown at the right-most limit of FIG. 2.

Based on the trends of FIG. 2, it is desired to limit the current applied across a motor such that, for a given operating temperature, the magnetic field strength does not increase into the demagnetizing region. It is reiterated that the curves depicted in FIG. 2 are merely illustrative and will depend at least on the magnetic material of the magnet. For a given magnet (e.g., of motor 120), memory 190 may store data corresponding to that of FIG. 2. Control circuitry 112 may rely on this data to establish one or more thresholds associated with implementing a three-phase short condition, implementing a three-phase open condition, and alternating between those conditions to prevent demagnetizing of the magnet.

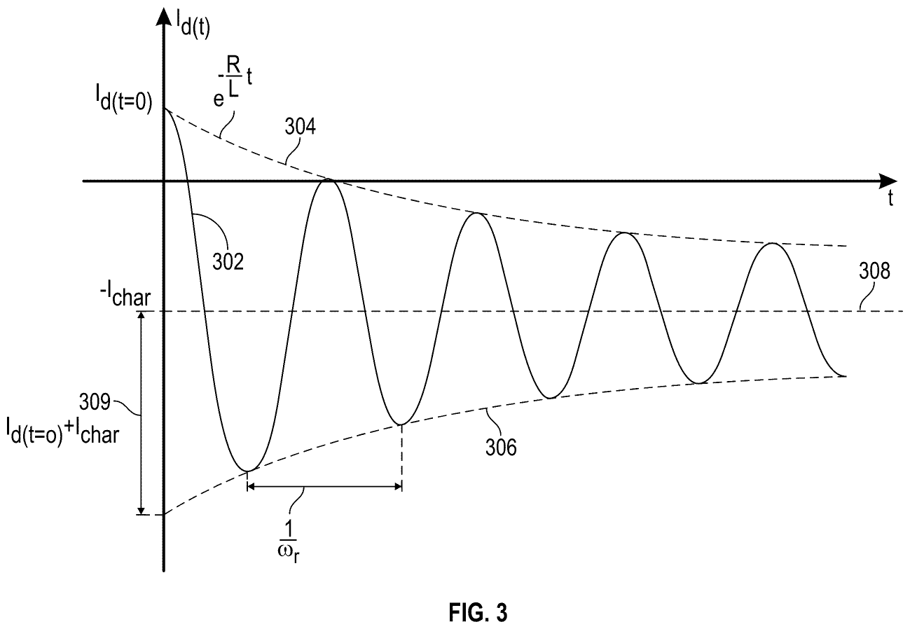

FIG. 3 is a first illustrative graph showing a transient current profile associated with a three-phase short condition. For example, the profile may represent a transient current that flows across motor 120 in response to control circuitry 112 implementing a three-phase short condition. After the three-phase short condition is implemented (e.g., the right side of the origin point shown in FIG. 3), transient current 302 (i.e., I_{d}(t)) develops as an oscillating current inside a decaying envelope with upper current limit 304 and lower current limit 306. The oscillating current oscillates around a characteristic current 308 (i.e., I_{char}). If given enough time (though this is not shown in FIG. 3), transient current 302 will stop oscillating (i.e., it will transition from a transient current to a steady-state current) and will reach a steady-state value equal to the characteristic current 308. As shown by annotation 309, a magnitude of envelope 306 at time t=0 may be defined with respect to I_{char} and may be equal to a value that is [I_{d}(t=0)+I_{char}] less than I_{char}. The magnitude of envelope 306 may depend on the motor speed. That is, the greater the motor speed, the greater the amplitude of the transient current oscillations and the greater the magnitude of the steady state current.

The rate of decay of the decaying envelope, which may be monitored or determined by control circuitry 112, may be given by e^{-Rt/L}, where R and L are a resistance and impedance, respectively, associated with a motor (e.g., motor 120). The rate of oscillations of current 302, of the decaying envelope, which may also be monitored or determined by control circuitry 112, may be given by 1/ωᵣ, where ωᵣ is an angular frequency of rotation associated with a motor (e.g., motor 120).

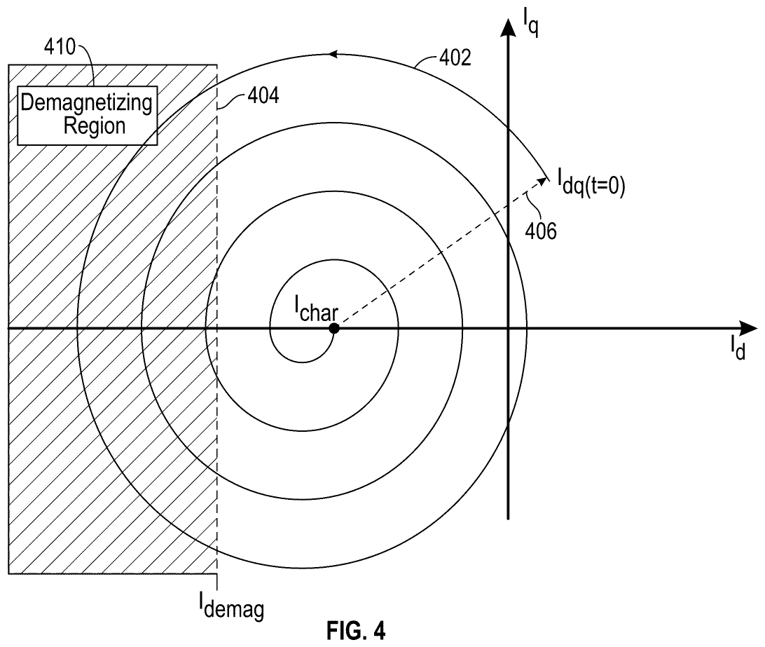

FIG. 4 is a second illustrative graph showing a transient current profile associated with a three-phase short condition. The graph of FIG. 4 includes a vertical axis representing current component I_{q} and a horizontal axis representing current component I_{d}. In some embodiments, current 402 shows current 302 represented as the sum of a first component (e.g., an in-phase component, which may be denoted I_{d}) and a second component (e.g., a quadrature component, which may be denoted I_{q}). Thus, the spiral progression of current 402, with directionality as indicated by the annotated arrow, may correspond to the temporal progression of current 302.

FIG. 4 shows a demagnetizing current limit 404, which may be a threshold associated with current 402 (e.g., based on a limiting magnitude of current component I_{d}). If current component I_{d} of current 402 exceeds the demagnetizing current limit 404, then a magnet (e.g., as is included within motor 120) may demagnetize. That is, if current component I_{d} of current 402 exceeds the demagnetizing current limit 404, then the magnetic field strength across a magnet associated with current 402 may be in a drop-off region as shown in FIG. 2.

In one illustrative example, a three-phase short condition is implemented, and current 402 varies from the initial value, as indicated by I_{dq}(t=0), to the steady state characteristic current value, as indicated by I_{char} (e.g., corresponding to I_{char} of FIG. 3). Because this illustrative example does not include alternating three-phase short and three-phase open conditions, current 402 exceeds the demagnetizing current limit 404. Prior to (or upon) implementing the three-phase short condition, the distance 406 (e.g., which may correspond to distance 309) between the steady state characteristic current value and the initial transient current value may be used (e.g., as a threshold, e.g., by control circuitry 112) to determine to alternate between the three-phase short condition and a three-phase open condition.

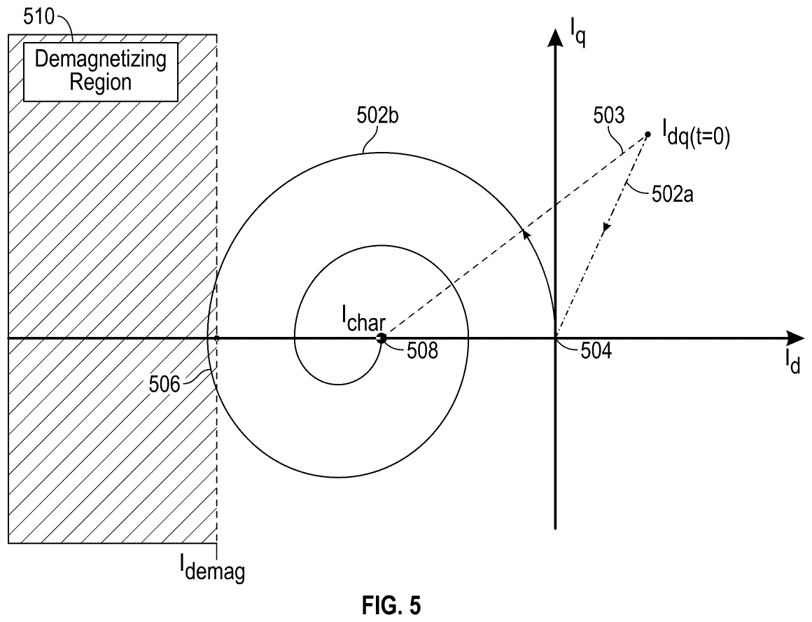

FIG. 5 is a third illustrative graph showing a transient current profile associated with a three-phase open condition followed by a three-phase short condition. Transient current 502 includes two portions, with transient current portion 502a corresponding to a three-phase open condition and transient current portion 502b corresponding to a three-phase short condition.

In some embodiments, FIG. 5 represents the progression of transient current 502 after control circuitry 112 determines to implement a three-phase short condition. In particular, FIG. 5 represents the progression of transient current 502 after control circuitry 112 implements a three-phase open condition and then implements a three-phase short condition. For example, based on the distance 503 between the initial value of transient current 502 and the characteristic current 508, control circuitry 112 may implement the open condition before the short condition to reduce the risk of transient current 502 exceeding the demagnetizing current limit 506.

In the approach of FIG. 5, which may be referred to as transitioning the motor to a three-phase short condition using an intermediate three-phase open condition, control circuitry 112 may determine that an initial magnitude of transient current 502 exceeds a threshold, implement the intermediate three-phase open condition until the transient current 502 reduces to zero, and then implement the three-phase short condition until the transient current 502 reaches its steady state value (e.g., the transient current 502 settles to the characteristic current 508). However, as shown by the portion 506 of transient current 502, the transient current passes through demagnetizing region 510. Therefore, the approach of FIG. 5 does not protect the motor magnet when the initial transient current magnitude is above a threshold.

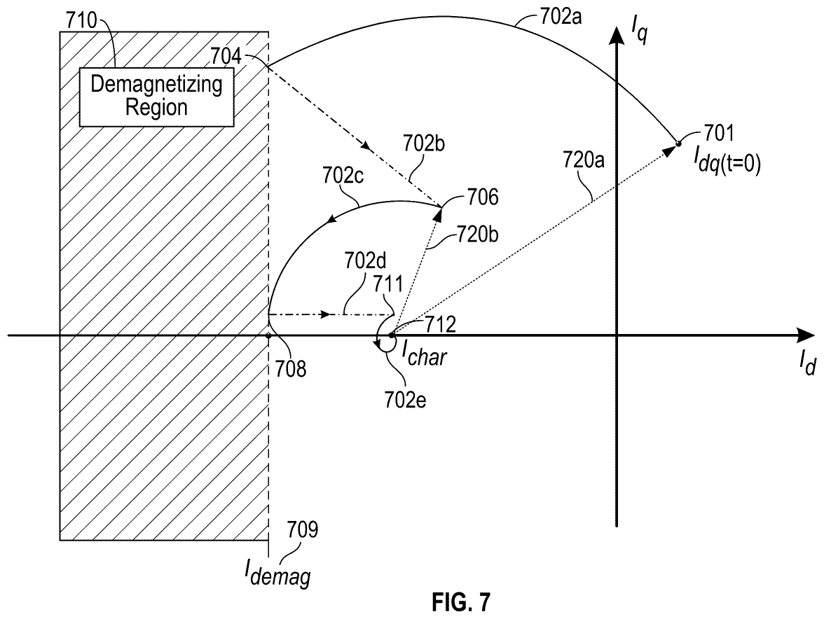

In accordance with some embodiments of this disclosure, FIG. 6 is an illustrative flowchart of a method 600 for transitioning a motor to a three-phase short condition by alternating between three-phase short and three-phase open conditions, and FIG. 7 is a fourth illustrative graph showing a current profile associated with a method for protecting a motor magnet during a three-phase short-circuit condition. For an illustrative and non-limiting example, the method 600 can be implemented to provide the current profile of FIG. 7.

In some embodiments, control circuitry 112 implements method 600 by controlling switches S₁-S₆ of motor drive 110. In some embodiments, control circuitry 112 implements method 600 to protect both motor 120 (e.g., to avoid demagnetizing a magnet of motor 120) and DC supply 150 (e.g., to prevent a backflow of current onto a battery of DC supply 150).

At 602, a three-phase short transition process is initiated. As used herein, the three-phase short transition process may refer to transitioning between a first mode of operation (e.g., in which switches S₁-S₆ are controlled to drive motor 120 (e.g., according to a desired torque to accelerate or decelerate electric vehicle 105) and a second mode of operation in which switches S₁-S₆ are controlled to protect power electronics (e.g., to provide a steady state three-phase short current across motor 120).

In some embodiments, control circuitry 112 determines to initiate the three-phase short transition process at 602 due to determining that at least one of a plurality of switches (e.g., any one of switches S₁-S₆) is damaged. In some embodiments, control circuitry 112 determines to initiate the three-phase short transition process at 602 due to determining that an electromotive force on a DC power supply, such as DC power supply 150 (e.g., as generated by a motor, such as motor 120), exceeds a threshold. In some embodiments, control circuitry 112 determines to initiate the three-phase short transition process at 602 due to determining that a current across a motor including a magnet (e.g., motor 120) exceeds a threshold.

At 604, a three-phase short condition is implemented. For example, the three-phase short condition may be implemented by closing all three of switches S₁-S₃ or all three of switches S₄-S₆. In any case, implementing the three-phase short condition includes causing there to be a short-circuit connection across each phase of a three-phase electric motor. In response to implementing the three-phase short condition, a transient current (e.g., transient current 302, 402, 502b, 702a) flows across motor 120.

At 606, it is determined whether a component of the transient current (e.g., I_{d}, as described above) approaches a demagnetizing limit. The demagnetizing limit may be estimated or determined based on a speed of the motor, a temperature, and/or properties of the motor. Moreover, it may be determined that the transient current is approaching the demagnetizing limit based on the transient current being, e.g., 50%, 60%, 70%, 80%, 85%, 90%, 95%, 99%, or any other suitable fraction of the demagnetizing limit. For an illustrative example, it may be determined that transient current 702a is within 5% of demagnetizing limit 709 and would therefore risk demagnetizing a motor magnet if further action is not taken. As a result, it may be determined that a three-phase open condition is required to prevent current 702 from passing through the demagnetizing region 710.

If it is determined at 606 that the component of the transient current approaches the demagnetizing limit, then at 608, a three-phase open condition is implemented. For example, in a first iteration of the flow of method 600, the three-phase open condition may cause the transient current 702 to flow according to the path shown by transient current portion 702b. Likewise, the transition between the three-phase short condition at 604 and the three-phase open condition at 608 may correspond to the time depicted at transition 704 of FIG. 7.

At 610, the difference (e.g., which is based on or equal to the distance, as mentioned below) between the transient current magnitude and the characteristic current magnitude is monitored. In some embodiments, the operations at 610 include determining the characteristic current magnitude I_{char} (e.g., based on the motor speed). In some embodiments, monitoring the difference includes the transient current being monitored as a transient current vector including two components (e.g., I_{d} and I_{q}, or phase and quadrature components, as described above), and the difference is monitored based on monitoring the distance between the tip of this vector and the characteristic current (e.g., I_{char} as described above, which may be also described as the steady state three-phase short current). For example, control circuitry 112 may monitor the distance between a time-dependent coordinate representing the transient current, such as (I_{d}, I_{q}), and a static coordinate representing the characteristic steady-state current, such as (I_{char}, 0).

At 612, it is determined whether the distance or difference monitored at 610 satisfies a threshold condition. For example, the threshold condition may be satisfied when the difference between the magnitude of I_{dq} and the magnitude of I_{char} is below a threshold value (e.g., the threshold value based on an initial value of I_{dq} during a corresponding three-phase short condition, the value of I_{char}, and a demagnetizing current limit such as I_{demag} 709). For another example, the threshold condition may be satisfied when the distance is a minimum distance between the transient current magnitude and the characteristic current magnitude. For another example, the threshold may be satisfied when the distance is at a predetermined amount based on the minimum distance between the transient current magnitude and the characteristic current magnitude (e.g., 1%, 5%, 10%, or any other suitable percent greater than the minimum distance). For another example, the threshold may be satisfied if the transient current magnitude is less than the characteristic steady-state current magnitude.

If, at 612, it is determined that the threshold condition is not satisfied, then the three-phase open condition is maintained and the operations at 608, 610, and 612 are repeated. However, if, at 612, it is determined that the threshold condition is satisfied, then a three-phase short condition is implemented as method 600 returns to the operation at 604 and the subsequent operations. For example, method 600 returning to the operation at 604 may correspond to the time depicted at transition 706 of FIG. 7, and/or the time depicted at transition 711 of FIG. 7.

As mentioned, method 600 includes the implementation of a first three-phase short condition at 604, a three-phase open condition at 608, and a second three-phase short condition at a subsequent iteration of 604. Thus, method 600 includes transitioning the electric motor to a first three-phase short condition (e.g., based on the first three-phase short condition) and then alternating between the three-phase short condition and a three-phase open condition (e.g., based on implementing at least one three-phase open condition at one or more iterations of 608 and based on implementing a corresponding number of three-phase short conditions at subsequent iterations of 604).

Returning to 606, if it is determined that the component of the transient current does not approach the demagnetizing limit, then at 614, it is determined whether a steady state three-phase short current condition is reached. In some embodiments, the steady state three-phase short current condition includes steady state flow of the characteristic current (e.g., I_{char} as shown in FIGS. 3-5 and 7) across the electric motor. If, at 614, it is determined that a steady state three-phase short current condition is reached, then at 616, the three-phase short transition process is terminated. That is, the alternating of three-phase short and three-phase open conditions is terminated in response to the transient current satisfying the steady state three-phase short current condition (e.g., the transient current has stabilized to a steady state current, or sufficiently close to a steady state current). For example, a determination at 614 that the transient current has satisfied the steady-state condition may include measuring a rate of change of the transient current and determining that the rate of change is below a threshold (e.g., the rate of change is sufficiently close to zero). For another example, a determination at 614 that the transient current has satisfied the steady-state condition may include determining that the transient current magnitude is within a threshold range (e.g., between 90%-110%, 98%-102%, or any other suitable range of proximity, of I_{char}) for a threshold amount of time. However, if, at 614, it is determined that a steady state three-phase short current condition is not reached, then method 600 returns to the operations at 604.

FIG. 7 illustrates a particular implementation of method 600. It is noted that the graph of FIG. 7 is arranged similarly to the graphs of FIGS. 4-5, but depicts a different approach for transitioning to the three-phase short condition.

At the initial time 701 of FIG. 7, a three-phase short condition is implemented (e.g., corresponding to the operations at 602 and 604) and the transient current 702 flows as shown by transient current portion 702a. While transient current portion 702a flows, the operation at 606 may be performed. Then, at the first alternation time 704, it is determined that the transient current 702 is approaching the demagnetizing limit 709. In some embodiments, the demagnetizing limit 709 includes a margin of error to ensure that the current does not reach the limit. That is, it may be determined that demagnetization occurs at a first current value, and the demagnetizing limit 709 may then be established as a fraction (e.g., 99%, 95%, 90%, or any other suitable fraction) of that first current value.

Accordingly, a three-phase open condition is implemented (e.g., corresponding to the operation at 608) is implemented and the transient current 702 flows as shown by transient current portion 702b. The transient current 702 does not enter the demagnetizing region 710 because of implementing the three-phase open condition at transition time 704. While transient current portion 702b flows, the operations at 610 and 612 may be performed. Then, at the second alternation time 706, it is determined that the transient current magnitude has sufficiently decreased (e.g., the transient current magnitude is less than the characteristic current magnitude, or the distance between the transient current magnitude and the characteristic current magnitude is at or suitably close to a minimum distance).

Accordingly, a three-phase short condition is implemented (e.g., corresponding to the operation at 604) and the transient current 702 flows as shown by transient current portion 702c. This transient current portion 702c again approaches the demagnetizing limit 709. Accordingly, the aforementioned operations of alternating to a second three-phase open condition (as shown by transient current portion 702d) at alternation time 708, and alternating to a third three-phase short condition (as shown by transient current portion 702e) at alternation time 711 occur.

Finally, transient current portion 702e stabilizes to the steady state three-phase short current (i.e., the characteristic current I_{char}) at time 712. The stabilizing at time 712 may correspond to the operations at 614 and 616.

The association between transient current vector 720 and transient current 702 is shown in FIG. 7 based on first illustrative transient current vector 720a and second illustrative transient current vector 720b. As transient current 702 varies, the base position of transient current vector 720 is maintained at the I_{char} coordinate, while the tip position of transient current vector 720 follows the present value of transient current 702.

During the execution of method 600, or any comparable approach for alternating between a three-phase short condition and a three-phase open condition, the length of transient current vector 720 (e.g., which is equivalent to the distance between the transient current and the steady state three-phase short current three-phase short current vector) may be monitored (e.g., by control circuitry 112). Control circuitry 112 may be configured to switch between the three-phase open condition and the three-phase short condition (e.g., at the transition between step 612 and step 604) when the length of transient current vector 720 is sufficiently small (i.e., it is “short enough”, as determined at step 612, it is at a minimum, or it is otherwise below a threshold value that may be defined with respect to the minimum).

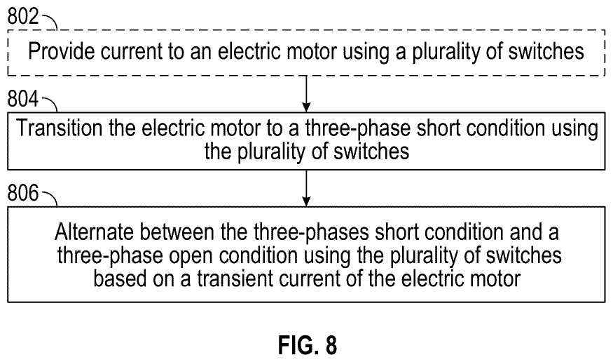

In accordance with some embodiments of this disclosure, FIG. 8 is an illustrative flowchart of a method 800 for protecting a motor during transition to a three-phase short condition. Method 800 may include some, or all, of method 600 and may result in a current profile that is similar to some, or all, of the illustrative current profile shown in FIG. 7.

At the optional operation of 802, current is provided (e.g., by control circuitry 112 or motor drive 110) to an electric motor (e.g., motor 120) using a plurality of switches (e.g., switches S₁-S₆). For example, the current may be provided to accelerate an electric vehicle that is driven by the motor.

At 804, it is determined (e.g., by the control circuitry) to transition the electric motor to a three-phase short condition using the plurality of switches. In some embodiments, the plurality of switches includes first, second, and third switches respectively coupled to first, second, and third phases of a three-phase electric motor, and transitioning the motor to the three-phase short condition includes closing the first, second, and third switches. In some embodiments, it is determined whether one of the plurality of switches is damaged, and transitioning to the three-phase short condition occurs in response to determining that at least one of the plurality of switches is damaged.

At 806, the condition of the motor is alternated between the three-phase short condition and a three-phase open condition using the plurality of switches based on a transient current associated with the motor. In some embodiments, the alternating occurs in response to the transient current exceeding a threshold. In some embodiments, the threshold is based a temperature associated with the three-phase motor, at least one magnetic property associated with the three-phase motor, or both. In some embodiments, the threshold is determined based on a comparison of the transient current and a steady state three-phase short current associated with the three-phase motor. In some embodiments, the steady state three-phase short current associated with the three-phase motor is based on one or more of the motor speed, at least one magnetic property of the three-phase motor, or a temperature associated with the three-phase motor.

For example, any one or more of the motor speed, a magnetic property of the motor, or the temperature associated with the motor may influence the susceptibility of the motor to demagnetizing. More specifically, any one or more of those properties may dictate the current levels associated with the demagnetizing region as depicted and described in connection with FIGS. 2, 4, 5, and 7.

In some embodiments, the alternating at 806 includes transitioning from the three-phase open condition (e.g., as implemented at 806) to the three-phase short condition (e.g., as implemented at 804) based on the transient current. For example, transitioning from the three-phase open condition to the three-phase short condition may occur when the transient current is less than the steady state three-phase short current, or when the difference between the transient current magnitude and the steady state three-phase short current magnitude is at (or near) a minimum distance.

In some embodiments, the alternating at 806 includes transitioning from the three-phase short condition (e.g., as implemented at 804, or as implemented after any subsequent alternating) to the three-phase open condition based on the transient current (e.g., based on monitoring the transient current vector or otherwise monitoring a distance between the transient current and the steady-state three-phase short current). For example, transitioning from the three-phase open condition to the three-phase short condition may occur when transient current vector is sufficiently short. In particular, the distance between the transient current vector and the steady-state three-phase short current is below a threshold distance. The threshold distance may be defined based on a demagnetizing current limit associated with a magnet of the three-phase motor, which may be further based on a temperature of the motor, a speed of the motor, an amount of voltage imbalance across the motor, or any combination thereof.

It is noted that in illustrative cases where a transient current includes multiple portions (e.g., including transient current portion 702a, transient current portion 702b, and so on), each of these multiple portions may indicate respective instances of applying one of a three-phase open condition or a three-phase short condition. The shared base reference numeral (e.g., as used in connection with transient current 702) that is applied to each of these current portions may be referred to when describing the transient current.

It is noted that as used herein, a transient current refers to a current with at least one time-dependent property. That is, at least one aspect of the current changes with time. In some embodiments, the transient current is described in contrast to a steady state current (e.g., where the steady state current may be referred to as a characteristic current).

The processes described above are intended to be illustrative and not limiting. One skilled in the art would appreciate that the steps of the processes described herein may be omitted, modified, combined and/or rearranged, and any additional steps may be performed without departing from the scope of the invention.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations thereto and modifications thereof, which are within the spirit of the following claims.

What is claimed is:

1. A system comprising:
power electronics configured to provide current to a three-phase electric motor using a plurality of switches; and
control circuitry configured to:
transition the three-phase electric motor to a three-phase short condition using the plurality of switches; and
alternate between the three-phase short condition and a three-phase open condition using the plurality of switches based on a transient current of the three-phase electric motor.

2. The system of claim 1, wherein the control circuitry is configured to alternate between the three-phase short condition and the three-phase open condition by transitioning the three-phase electric motor from the three-phase short condition to the three-phase open condition in response to the transient current exceeding a threshold.

3. The system of claim 2, wherein the control circuitry is configured to determine the threshold based on a temperature associated with the three-phase electric motor.

4. The system of claim 1, wherein the control circuitry is configured to alternate between the three-phase short condition and the three-phase open condition by transitioning the three-phase electric motor from the three-phase open condition to the three-phase short condition based on the transient current and a steady state three-phase short current of the three-phase electric motor.

5. The system of claim 4, wherein the control circuitry is configured to determine the steady state three-phase short current based on motor speed.

6. The system of claim 4, wherein the control circuitry is configured to transition the three-phase electric motor from the three-phase open condition to the three-phase short condition when a distance between a vector associated with the transient current and the steady state three-phase short current is below a threshold distance.

7. The system of claim 1, wherein the control circuitry is further configured to:
determine whether the transient current satisfies a steady state three-phase short current condition; and
terminate the alternating in response to the transient current satisfying the steady state three-phase short current condition.

8. The system of claim 1, wherein the control circuitry is further configured to:
determine whether one of the plurality of switches is damaged; and
transition the three-phase electric motor to the three-phase short condition in response to determining that one of the plurality of switches is damaged.

9. The system of claim 1, wherein:
the plurality of switches comprises first, second, and third switches respectively coupled to first, second, and third phases of the three-phase electric motor; and
the control circuitry is configured to transition the three-phase electric motor to the three-phase short condition by closing the first, the second, and the third switches.

10. A method comprising:
transitioning, using control circuitry, a three-phase electric motor to a three-phase short condition using a plurality of switches; and
alternating, using the control circuitry, between the three-phase short condition and a three-phase open condition using the plurality of switches based on a transient current of the three-phase electric motor.

11. The method of claim 10, wherein alternating between the three-phase short condition and the three-phase open condition comprises transitioning the three-phase electric motor from the three-phase short condition to the three-phase open condition in response to the transient current exceeding a threshold.

12. The method of claim 11, further comprising determining the threshold based on a temperature associated with the three-phase electric motor.

13. The method of claim 10, wherein alternating between the three-phase short condition and the three-phase open condition comprises transitioning the three-phase electric motor from the three-phase open condition to the three-phase short condition based on the transient current and a steady state three-phase short current of the three-phase electric motor.

14. The method of claim 13, further comprising determining the steady state three-phase short current based on motor speed.

15. The method of claim 13, further comprising transitioning the three-phase electric motor from the three-phase open condition to the three-phase short condition when a distance between a vector associated with the transient current and the steady state three-phase short current is below a threshold distance.

16. The method of claim 10, further comprising:
determining whether the transient current satisfies a steady state three-phase short current condition; and
terminating the alternating in response to the transient current satisfying the steady state three-phase short current condition.

17. The method of claim 10, further comprising:
determining whether one of the plurality of switches is damaged; and
transitioning the three-phase electric motor to the three-phase short condition in response to determining that one of the plurality of switches is damaged.

18. The method of claim 10, wherein the plurality of switches comprises first, second, and third switches respectively coupled to first, second, and third phases of the three-phase electric motor; wherein:
transitioning the three-phase electric motor to the three-phase short condition comprises closing the first, the second, and the third switches.

19. An electric vehicle comprising:
a three-phase electric motor coupled to one or more wheels;
power electronics configured to provide current to the three-phase electric motor using a plurality of switches; and
control circuitry configured to:
transition the three-phase electric motor to a three-phase short condition using the plurality of switches; and
alternate between the three-phase short condition and a three-phase open condition using the plurality of switches based on a transient current of the three-phase electric motor.

20. The electric vehicle of claim 19, wherein the control circuitry is configured to alternate between the three-phase short condition and the three-phase open condition by transitioning the three-phase electric motor from the three-phase short condition to the three-phase open condition in response to the transient current exceeding a threshold.
